(19) United States
(12) Patent Application Publication
(10) Pub. No.: US 2014/0091718 A1
(43) Pub. Date: Apr. 3, 2014

(54) Power Converter with an Inductor-Inductor-Capacitor Stage and Method of Operating the Same

(71) Applicant: POWER SYSTEMS TECHNOLOGIES, LTD., Ebene (MU)

(72) Inventor: Antony Brinlee, Plano, TX (US)

(73) Assignee: POWER SYSTEMS TECHNOLOGIES, LTD., Ebene (MU)

(21) Appl. No.: 13/631,495

(22) Filed: Sep. 28, 2012

(51) Int. Cl. H02M 3/335; H05B 37/00

(52) U.S. Cl. 315/185 R; 363/16

(57) ABSTRACT

A power converter including an inductor-inductor-capacitor stage and method of operating the same. In one embodiment, the power converter includes an inductor-inductor-capacitor (LLC) stage coupled to an input of said power converter. The power converter also includes a controller configured to control a switching frequency of the LLC stage as a function of an input voltage of the power converter.

### TECHNICAL FIELD

The present invention is directed, in general, to power electronics and, more specifically, to a power converter including an inductor-inductor-capacitor (“LLC”) stage and method of operating the same.

### BACKGROUND

A switched-mode power converter (also referred to as a “power converter” or “regulator”) is a power supply or power processing circuit that converts an input voltage waveform into a specified output voltage or current waveform. Controllers associated with the power converters manage an operation thereof by controlling conduction periods and/or switching frequencies of power switches employed therein. Generally, the controllers are coupled between an input and output of the power converter in a feedback loop configuration (also referred to as a “control loop” or “closed control loop”).

Typically, the controller measures an output characteristic (e.g., an output voltage, an output current, or a combination of an output voltage and an output current) of the power converter, and based thereon modifies a duty cycle or a switching frequency of a power switch of the power converter. The duty cycle “D” is a ratio represented by a conduction period of a power switch to a switching period thereof. Thus, if a power switch conducts for half of the switching period, the duty cycle for the power switch would be 0.5 (or 50 percent). Additionally, as the voltage or the current for a load (e.g., a string of light emitting diodes powered by the power converter) dynamically changes (e.g., as a temperature of the string of light emitting diodes changes), the controller should dynamically modify the duty cycle and/or the switching frequency of the power switches therein to maintain an output characteristic (e.g., an output current) at a desired value.

Market requirements have prompted continual improvements in power conversion efficiency of power converters employed to power a string of light emitting diodes. New technologies to produce an efficient light source such as compact fluorescent bulbs are substantial improvements over incandescent technology. The new light sources, however, may introduce new hazards such as inclusion of toxic elements in their design such as mercury that is dispersed in the environment when the bulb is broken or discarded into a landfill.

Thus, despite the development of light emitting diode technologies to provide an efficient illumination source, no strategy has emerged to provide substantial improvement in power converter efficiency to provide a direct current (“dc”) current to power a string of light emitting diodes formed in a light bulb with suitably high power factor. Accordingly, what is needed in the art is a design approach and related method for a power converter for a string of light emitting diodes that can be advantageously adapted to the high-volume/low-cost manufacturing techniques that are necessary for the marketplace.

### SUMMARY OF THE INVENTION

These and other problems are generally solved or circumvented, and technical advantages are generally achieved, by advantageous embodiments of the present invention, including a power converter including an inductor-inductor-capacitor stage and method of operating the same. In one embodiment, the power converter includes an inductor-inductor-capacitor (“LLC”) stage coupled to an input of the power converter. The power converter also includes a controller configured to control a switching frequency of the LLC stage as a function of an input voltage of the power converter.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a power converter including a controller constructed according to the principles of the present invention;

FIG. 2 illustrates a circuit diagram of an embodiment of a power converter formed with a bridge rectifier coupled to an LLC stage constructed according to the principles of the present invention;

FIG. 3 illustrates a graphical representation of an exemplary voltage gain for the LLC stage of FIG. 2 as a function of a switching frequency in accordance with the principles of the present invention;

FIG. 4 illustrates a graphical representation of an exemplary output voltage and input currents of the power converter of FIG. 2 in accordance with the principles of the present invention;

FIG. 5 illustrates a graphical representation of an exemplary switching frequency of the LLC stage of FIG. 2 in accordance with the principles of the present invention;

FIG. 6 illustrates a graphical representation of exemplary relationships between a rectified input voltage and an input current of the power converter of FIG. 2 in accordance with the principles of the present invention; and

FIG. 7 illustrates a block diagram of an embodiment of a portion of the controller of the power converter of FIG. 2 constructed according to the principles of the present invention.

Corresponding numerals and symbols in the different figures generally refer to corresponding parts unless otherwise indicated, and may not be redescribed in the interest of brevity after the first instance. The FIGUREs are drawn to illustrate the relevant aspects of exemplary embodiments.

### DETAILED DESCRIPTION OF ILLUSTRATIVE EMBODIMENTS

The making and using of the present exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to exemplary embodiments in a specific context, namely, a power converter coupled to and configured to illuminate a string of light emitting diodes. While the principles of the present invention will be described in the environment of a power converter coupled to a string of light emitting diodes, any application that may benefit from a power conversion device including a power converter such as a power amplifier or a motor controller is well within the broad scope of the present invention.

A power converter formed with a bridge rectifier front-end followed by an inductor-inductor-capacitor (“LLC”) stage can be employed to provide a power source with high power factor for a string of light emitting diodes. A light emitting diode string is generally formed with a series circuit arrangement of a number of individual light emitting diodes. A light emitting diode when it is illuminated has a forward voltage drop of about four to five volts that can vary with light emitting diode forward current, temperature, age and manufacturing variations, and produces illumination when it conducts a forward current that is generally a fraction of an ampere.

The power converter may be formed without a power factor correction (“PFC”) front end, and the gain of the LLC stage is adjusted to be roughly inversely proportional to the input voltage to achieve an acceptable level of power factor correction. The LLC stage is operated close to resonance most of the time, particularly near the peak of the input voltage, to achieve high power conversion efficiency. At low values of the input voltage (e.g., at about 20 percent or about 73 volts on a rectified 374 volt system, which is a peak line voltage for a 264 volt root-mean-square alternating current (“ac”) line input), the switching frequency is reduced to increase the gain of the LLC stage, which broadens the conduction range of the input current over an alternating current cycle. In this manner, a conduction angle of about 80 degrees for the ac input current can be achieved with reasonable power factor without the need for a dedicated power factor correction stage. The LLC stage produces a current source at its output dependent on an impedance of an output tank circuit thereof.

As an example, a light bulb is powered by a power converter operable over an ac input voltage range of 190 to 264 volts root-mean-square (“RMS”) with a peak voltage of 372 volts at an RMS input voltage of 264 volts. At 190 volts RMS, a nominal switching frequency of 50 kilohertz (“kHz”) is employed for the LLC stage. The RMS value of the input voltage can be sensed to set the nominal switching frequency of the LLC stage by, for instance, sensing the previous ac input voltage cycle with an analog-to-digital (“A/D”) converter coupled to a controller comprising a microprocessor. The nominal switching frequency of the LLC stage is modulated by a controller to provide partial current fill-in for the ac input current for improved power factor. The controller employs both the RMS and instantaneous value of the input voltage to set the switching frequency of the LLC stage. The output tank impedance sets the level of the output current that is fed to the light emitting diode string at a particular switching frequency of the LLC stage. The switching frequency of the LLC stage is decreased thereby increasing either the output current of the power converter or the LLC tank current. In general, the voltage gain of an LLC stage is highest at its resonant frequency, and declines at frequencies on either side of its resonant frequency. The resulting design provides high efficiency and high power factor with reduced size and cost, and without the need for electrolytic capacitors which exhibit limited life in a high-temperature environment.

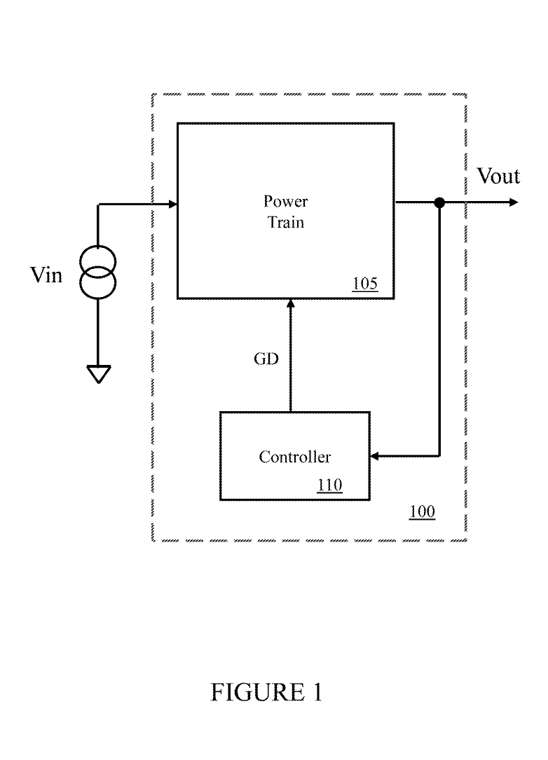

Referring initially to FIG. 1, illustrated is a block diagram of an embodiment of a him and him power converter 100 including a controller 110 constructed according to the principles of the present invention. The power converter 100 is coupled to ac mains represented by the ac power source providing an input voltage Vin. The power converter includes a power train 105 that is controlled by the controller 110. The controller 110 generally measures an operating characteristic of the power converter such as its output voltage Vout and/or its output current and controls a power switch therein with a control signal GD coupled to a control terminal of the power switch to produce a duty cycle D at a switching frequency (often designated as “fs”) in response to the measured operating characteristic to regulate the operating characteristic. The power train 105 of the power converter includes a plurality of power switches coupled to a magnetic device to provide the power conversion function.

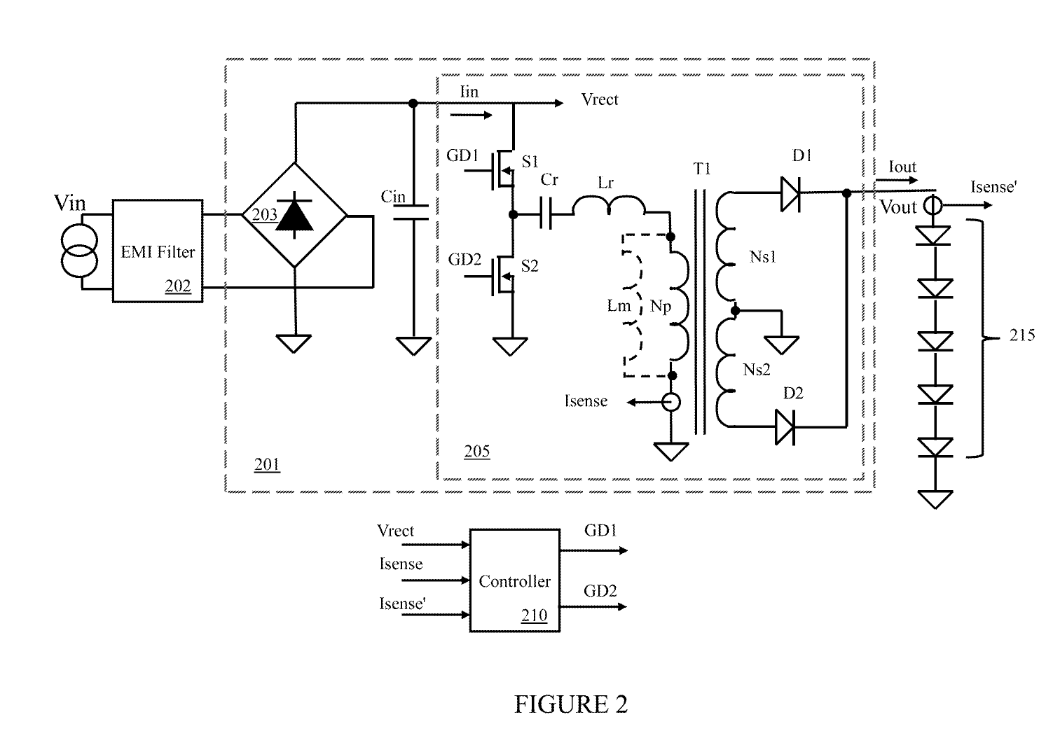

Turning now to FIG. 2, illustrated is a circuit diagram of an embodiment of a power converter formed with a bridge rectifier (e.g., a four-diode bridge rectifier) 203 coupled to an inductor-inductor-capacitor (“LLC”) stage (e.g., a half-bridge LLC isolated resonant buck stage) 205 constructed according to the principles of the present invention. The bridge rectifier 203 coupled to the LLC stage 205 can be employed to construct a power source to provide a unipolar voltage to illuminate a string of light emitting diodes 215 from an ac mains input voltage source (represented by an ac mains voltage or input voltage Vin). In an alternative embodiment, the LLC isolated resonant buck stage 205 is formed with a full-bridge architecture.

A power train 201 formed with the LLC stage 205 of the power converter includes power switches S1, S2 coupled to the ac mains voltage Vin, an electromagnetic interference (“EMI”) filter 202, the bridge rectifier 203 and an input filter capacitor Cin to provide a unipolar rectified input voltage Vrect and input current Iin to a magnetic device (e.g., an isolating transformer or transformer T1). Although the EMI filter 202 illustrated in FIG. 2 is positioned between the ac mains voltage Vin and the bridge rectifier 203, the EMI filter 202 may contain filtering components positioned between the bridge rectifier 203 and the transformer T1. The transformer T1 has a primary winding Np and first and second secondary windings Ns1, Ns2 with a turns ratio that is selected to provide an output voltage Vout with consideration of a resulting switching frequency fs of the LLC stage 205 and stress on power train components.

The power switches S1, S2 (e.g., n-channel field-effect transistors) are controlled by a controller 210 that controls the power switches S1, S2 to alternately conduct respectively for a duty cycle D and a complementary duty cycle 1-D. The power switches S1, S2 alternately conduct in response to gate drive signals GD1, GD2 produced by the controller 210 with the switching frequency fs. In an embodiment, the duty cycle D for one power switch and the complementary duty cycle for the other power switch are substantially equal, each slightly less than 50 percent to prevent cross conduction of the power switches S1, S2. The switching frequency fs is controlled to regulate an output characteristic of the power converter such as the output voltage Vout, an output current Tout that is supplied to the string of light emitting diodes 215, or a combination thereof.

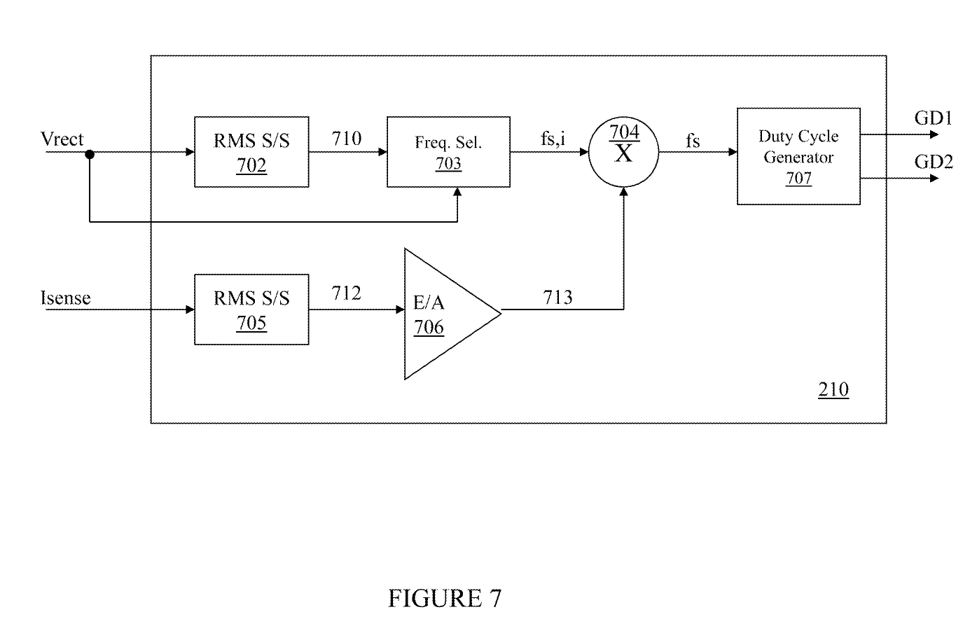

A feedback signal (e.g., Isense or Isense′) enables the controller 210 to control the switching frequency fs to regulate the output characteristic of the power converter such as the current fed (e.g., the output current Tout) to the string of light emitting diodes 215. A voltage-controlled oscillator (“VCO”, not shown in FIG. 2) in the controller 210 can be employed to control the switching frequency fs of the LLC stage 205. When the controller 210 is formed with a microprocessor, a microprocessor can be readily programmed to control the switching frequency fs of the LLC stage 205 as described hereinbelow with reference to FIG. 7. The ac voltages appearing on the secondary windings Ns1, Ns2 of the transformer T1 are rectified by first and second diodes D1, D2, and the resulting rectified waveforms are coupled to the output to produce the output voltage Vout and the output current lout to power the string of light emitting diodes 215.

The transformer/stage gain of the LLC stage 205 is employed with a control loop in a frequency region between 1/(2π·sqrt((Lm+Lk)·Cr)) and 1/(2π·sqrt(Lk·Cr)) to increase power factor of the power converter. The LLC stage 205 is operated most of the time at or near its resonant frequency, at which point its power conversion efficiency is generally best. By operating the LLC stage 205 most of the time at or near its resonant frequency, but allowing the switching frequency fs to change (e.g., be reduced) in response to changes in the rectified input voltage Vrect, improved power factor correction can be obtained while maintaining high power conversion efficiency.

The transformer/stage gain of the LLC stage is employed in the frequency region between 1/(2π·sqrt((Lm+Lk)·Cr)) and 1/(2π·sqrt(Lk·Cr)) to broaden the range of time during which ac current is applied to the power converter. The primary inductance of the transformer T1 is the leakage inductance Lk plus the magnetizing inductance Lm, both inductances referenced to the primary winding Np of the transformer T1. The resonant capacitor is Cr and the resonant inductor Lr are coupled in series with a winding (e.g., the primary winding Np) of the transformer T1. The leakage inductance Lk of the transformer T1 is included in the resonant inductor Lr.

In an embodiment, the resonant capacitor Cr can be split into two capacitors coupled in a series circuit, one end of the series circuit coupled to ground and the other end coupled to the rectified input voltage Vrect. A series circuit arrangement can be employed to reduce inrush current at startup. An ideal switching frequency fo is fo=1/(2π·sqrt(Lk·Cr)), which is normally the high-efficiency operating point (e.g., 50 kilohertz (“kHz”)). A low switching frequency fmin at which inefficient capacitive switching starts is fmin=1/(2π·sqrt(Lr·Cr)). It is generally desired to operate at switching frequencies fs greater than the low switching frequency fmin, and even avoid switching frequencies fs that approach the low switching frequency fmin.

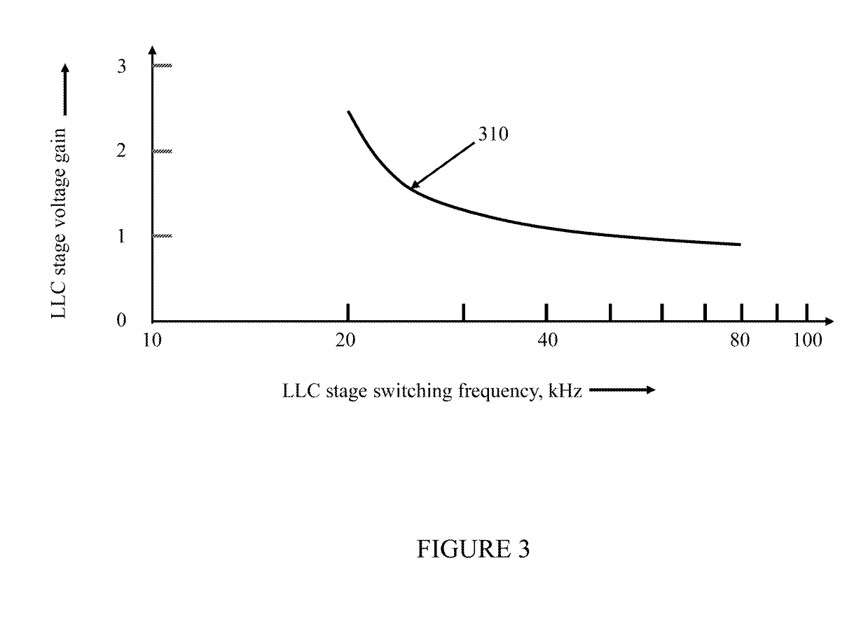

Turning now to FIG. 3, illustrated is a graphical representation of an exemplary voltage gain 310 for the LLC stage 205 of FIG. 2 as a function of a switching frequency fs in accordance with the principles of the present invention. The output voltage Vout at a particular rectified input voltage Vrect depends in a nonlinear way on the switching frequency fs. As the rectified input voltage Vrect is reduced, the output voltage Vout is approximately proportionately reduced if the switching frequency fs is not altered. The result is the switching frequency fs is varied to control the output voltage Vout and the output current lout flowing through the string of light emitting diodes 215, and correspondingly to control the input current Iin as the rectified input voltage Vrect varies. It is recognized that the effect of changing the switching frequency fs on the output voltage Vout is nonlinear and it is contemplated that it can be compensated/corrected. The voltage transfer characteristic or gain 310 of the LLC stage 205 is employed to broaden the period of time over an ac cycle during which the ac input current to the power converter flows.

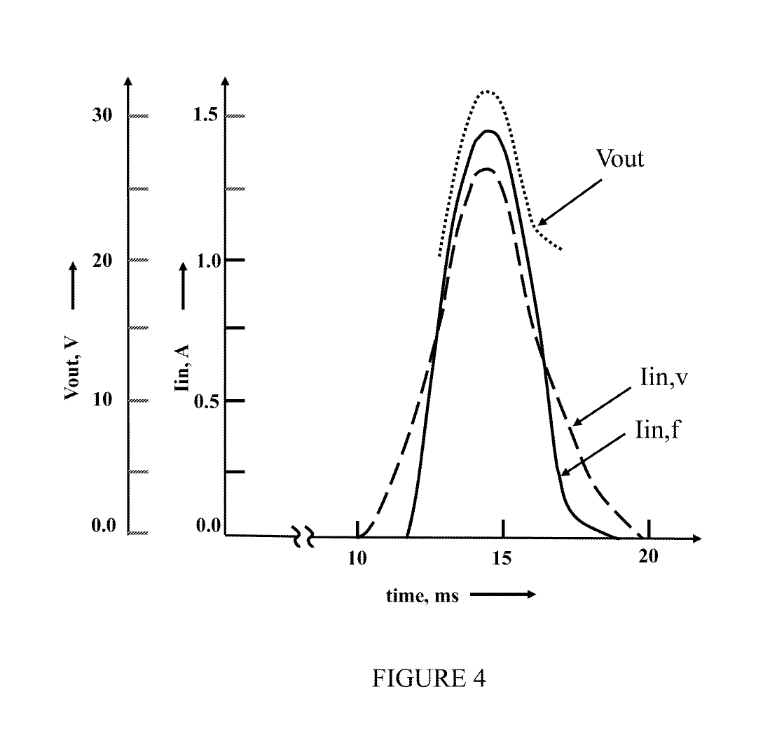

Turning now to FIG. 4, illustrated is a graphical representation of an exemplary output voltage Vout, an input current Iin,f for a fixed switching frequency fs and an input current Iin,v when the switching frequency fs is varied roughly inversely over a range of values of the rectified input voltage Vrect of the power converter of FIG. 2 in accordance with the principles of the present invention. As can be observed in FIG. 4, the conduction angle of the input current Iin,v over an ac cycle can be broadened by varying the switching frequency fs roughly inversely to the rectified input voltage Vrect.

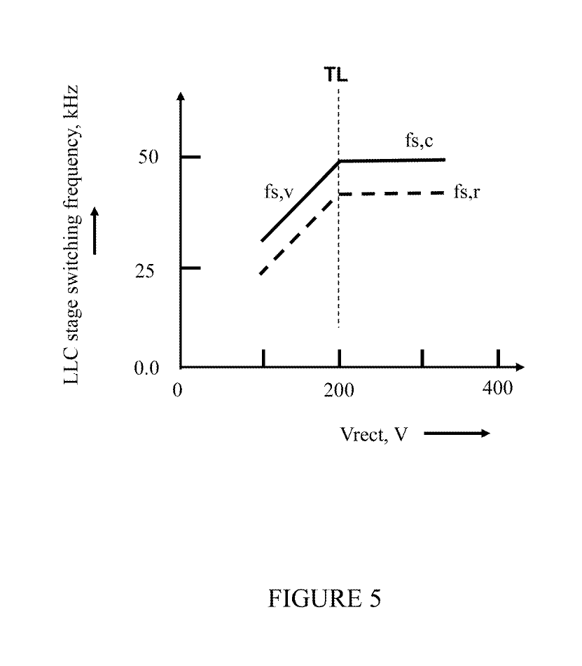

Turning now to FIG. 5, illustrated is a graphical representation of an exemplary switching frequency fs of the LLC stage 205 of FIG. 2 as a function of the rectified input voltage Vrect in accordance with the principles of the present invention. As illustrated in FIG. 5, the switching frequency fs can be represented by a broken line as a function of the rectified input voltage Vrect. When the rectified input voltage Vrect is greater than a threshold level TL of about 200 volts (“V”), the switching frequency fs is set to a constant, nominal value of about 50 kHz (designated as “fs,c”) to provide high power conversion efficiency. For lower values of the rectified input voltage Vrect, the switching frequency fs varies and is reduced (designated as “fs,v”) as a function of the rectified input voltage Vrect to increase the gain of the LLC stage 205. In an embodiment, the function can be a nonlinear function. However, since the LLC stage 205 conducts a generally lower current level at lower instantaneous values of the rectified input voltage Vrect, an insignificant and modest loss of power conversion efficiency at reduced switching frequencies fs may occur.

The switching frequency fs of the LLC stage 205 is set to a lower value by the controller 210 at a reduced root-mean-square (“RMS”) input voltage to the power converter to produce a higher overall voltage gain at a reduced input voltage Vin (represented by a reduced switching frequency fs,r). The controller 210 can sample the rectified input voltage Vrect over a previous ac cycle or portion thereof to sense the RMS input voltage applied to the power converter. The switching frequency fs is also adjusted by the controller 210 dependent on a feedback signal such as the current sense signal Isense, Isense′ to maintain a desired average current in the string of light emitting diodes 215. Such a feedback signal can be employed to compensate for light emitting diode aging, temperature-dependent variations in light emitting diode forward voltage drop, manufacturing variations, etc.

For a given rectified input voltage Vrect (e.g., produced by an ac mains voltage Vin of 230 volts, root mean squared (“Vrms”)) the frequency of the LLC stage 205 would remain at or near resonance over a substantial portion of the load range. However, once the RMS value of the ac mains voltage Vin exceeds about 230 Vrms to 235 Vrms, or even up to 264 Vrms or more, then the switching frequency fs of the LLC stage 205 can be increased and the gain of the LLC stage 205 is correspondingly reduced to maintain an output current Tout that does not exceed a preset value. Once the RMS value of the ac mains voltage Vin exceeds, for instance, 230 Vrms, the switching frequency fs of the LLC stage 205 is increased, which produces a half cycle flat top input current waveform. On the next cycle, the peak switching frequency is used as an operational frequency to obtain a roughly sine wave input current during the next half cycle. For example, if the LLC stage 205 operates at a RMS value of the ac mains voltage Vin of 230 Vrms and 50 kHz in the last half cycle and an ac line surge occurs to 264 Vrms, then, during the first half cycle, a peak current is obtained and the switching frequency of the LLC stage 205 is increased (say to 100 kHz) to maintain a maximum allowable current, producing a flat top on the output current Tout. During the next half cycle, the maximum switching frequency for the LLC stage 205 from the last half wave (at 100 kHz) is used as the new switching frequency fs so that as long as the RMS value of the ac mains voltage Vin of 264 Vrms is maintained, the ac input current waveform would be closer to a sinusoidal waveform.

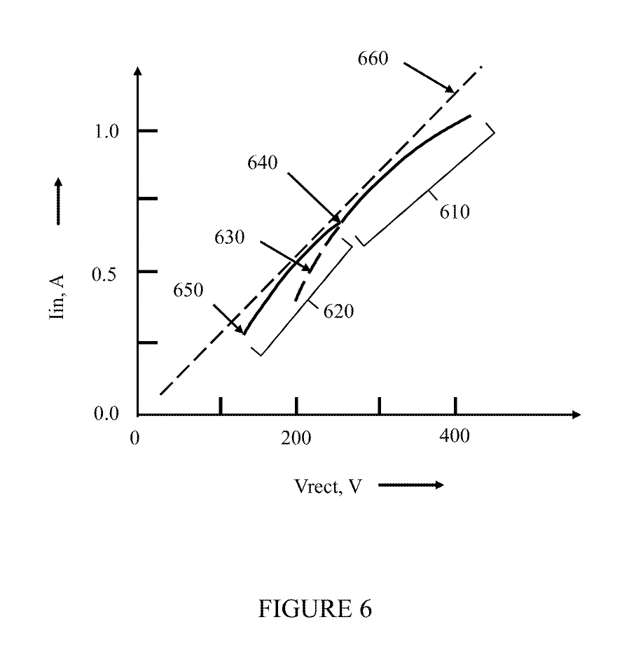

Turning now to FIG. 6, illustrated is a graphical representation of exemplary relationships between the rectified input voltage Vrect and the input current Iin of the power converter of FIG. 2 in accordance with the principles of the present invention. The dashed curve 660 represents an ideal linear relationship between the rectified input voltage Vrect and the input current lin that results in power factor reasonably close to unity for the power converter. When the input current Iin and the rectified input voltage Vrect are proportional to each other, the power converter exhibits the characteristic of a linear resistor thereby producing substantially unity power factor, ignoring small currents absorbed by the EMI filter 202 and small capacitive elements coupled in parallel with the input to the power converter.

The relationship between the input current lin and the rectified input voltage Vrect for high values of the rectified input voltage Vrect with a fixed switching frequency fs between the input current Iin and the rectified input voltage Vrect of the LLC stage 205 is represented by the portion 610 of the solid curve illustrated in FIG. 6. For practical purposes, this portion 610 of the relationship between the input current Iin and the rectified input voltage Vrect produces high power factor as well as high power conversion efficiency. However, at lower instantaneous values of the rectified input voltage Vrect, the approximate linear relationship between the input current Iin and the rectified input voltage Vrect is lost as illustrated by the dashed portion 630 of the curve. By reducing the switching frequency fs of the LLC stage 205, the resulting curve 620 from the point 640 to the point 650 is produced, which provides improvement in power factor by extending the conduction angle of the input ac current to the power converter. The relationship between the switching frequency fs and the rectified input voltage Vrect is as illustrated and described previously hereinabove with reference to FIG. 5.

Turning now to FIG. 7, illustrated is a block diagram of an embodiment of a portion of the controller 210 of the power converter of FIG. 2 constructed according to the principles of the present invention. The controller 210 samples the rectified input voltage Vrect over at least a portion of a previous cycle of the ac input voltage and, in an RMS subsystem (“S/S”) 702, computes an RMS value 710 of the ac input voltage. A frequency selector 703 employs the RMS value 710 of the rectified input voltage Vrect and its instantaneous value to compute an initial switching frequency fs,i of the LLC stage 205, using, for example, a function as described hereinabove with reference to FIG. 5. In an embodiment, the nominal switching frequency fs of the LLC stage 205 is modulated dependent on an instantaneous value of the rectified input voltage Vrect. In an embodiment, the switching frequency fs is reduced at low instantaneous values of the rectified input voltage Vrect. In an embodiment, the RMS and instantaneous value of the rectified input voltage Vrect are employed to set the switching frequency fs of the LLC stage 205.

An RMS subsystem 705 computes an RMS value 712 of the feedback signal Isense representative of a current fed (e.g., the output current lout) to the string of light emitting diodes 215. In an alternative embodiment, the RMS subsystem 705 computes an RMS value 712 of the feedback signal Isense′. In an alternative embodiment, another functional value such as an average magnitude value is computed in place of the RMS value 712. An error amplifier (“E/A) 706 produces an error signal 713 representative of a difference between the RMS value 712 and a desired RMS value for the feedback signal Isense (or alternatively, the feedback signal Isense′). In an embodiment, the error signal 713 is constrained to lie between 0.8 and 1.1.

A multiplier 704 multiplies the initial switching frequency fs,i by the error signal 713 to produce a switching frequency fs for the LLC stage 205. In an embodiment, the switching frequency fs of the LLC stage 205 is varied roughly inversely with the rectified input voltage Vrect over a range of values thereof. A duty cycle generator 707 employs the switching frequency fs to compute the gate drive signals GD1, GD2 with sufficient temporal separation therebetween to prevent cross conduction of the power switches S1, S2. In this manner, a variable switching frequency fs is produced for the LLC stage 205 and is adjusted to accommodate variations in light emitting diode forward voltage drop, manufacturing variations, etc.

Thus, a power converter including an LLC stage and method of operating the same have been introduced herein. In one embodiment, the power converter includes a bridge rectifier (e.g., a four-diode bridge rectifier) and an LLC stage (e.g., a half-bridge LLC isolated resonant buck stage) coupled to the bridge rectifier. The power converter also includes a controller configured to control a switching frequency of the LLC stage as a function of an input voltage of the power converter. The power converter is configured to power a string of light emitting diodes.

In various embodiments, the controller is configured to provide a constant switching frequency for an input voltage greater than a threshold level. The controller is also configured to reduce the switching frequency at low instantaneous values of the input voltage. The controller is also configured to sense a root-mean-square value of the input voltage to determine the switching frequency of the LLC stage. The controller is also configured to modulate the switching frequency of the LLC stage based on an instantaneous value of the input voltage. The controller is also configured to employ a root-mean-square value and an instantaneous value of the input voltage to control the switching frequency of the LLC stage. The controller is also configured to receive a feedback signal dependent on a current to control the switching frequency of the LLC stage. The controller is also configured to vary the switching frequency of the LLC stage inversely with an instantaneous value of the input voltage over a range of instantaneous values thereof.

The controller or related method may be implemented as hardware (embodied in one or more chips including an integrated circuit such as an application specific integrated circuit), or may be implemented as software or firmware for execution by a processor (e.g., a digital signal processor) in accordance with memory. In particular, in the case of firmware or software, the exemplary embodiment can be provided as a computer program product including a computer readable medium embodying computer program code (i.e., software or firmware) thereon for execution by the processor.

Program or code segments making up the various embodiments may be stored in the computer readable medium. For instance, a computer program product including a program code stored in a computer readable medium (e.g., a non-transitory computer readable medium) may form various embodiments. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, and the like.

Those skilled in the art should understand that the previously described embodiments of a power converter including circuits to alter a switching frequency of an LLC stage and related methods of operating the same are submitted for illustrative purposes only. For example, in a further embodiment, a power converter that uses a half-wave diode bridge instead of full-wave diode bridge can use techniques described herein. For example, the four-diode bridge rectifier 203 illustrated in FIG. 2 could be replaced with a single diode. While a power converter employing an LLC stage to improve power factor correction and power conversion efficiency has been described in the environment of a power converter to provide an illuminating current four a string of light emitting diodes, these processes may also be applied to other systems such as, without limitation, a power amplifier or a motor controller.

For a better understanding of power converters, see “Modern DC-to-DC Power Switch-mode Power Converter Circuits,” by Rudolph P. Severns and Gordon Bloom, Van Nostrand Reinhold Company, New York, N.Y. (1985) and “Principles of Power Electronics,” by J. G. Kassakian, M. F. Schlecht and G. C. Verghese, Addison-Wesley (1991). For related applications, see U.S. Patent Application Publication No. 2008/0130321, entitled “Power Converter with Adaptively Optimized Controller and Method of Controlling the Same,” to Artusi, et al., published Jun. 5, 2008, U.S. Patent Application Publication No. 2008/0130322, entitled “Power System with Power Converters Having an Adaptive Controller,” to Artusi, et al., published Jun. 5, 2008, and U.S. Patent Application Publication No. 2008/0232141, entitled “Power System with Power Converters Having an Adaptive Controller,” to Artusi, et al., published Sep. 25, 2008. The aforementioned references are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A power converter, comprising:
an inductor-inductor-capacitor (LLC) stage coupled to an input of said power converter; and
a controller configured to control a switching frequency of said LLC stage as a function of an input voltage of said power converter.

2. The power converter as recited in claim 1 wherein said LLC stage is a half-bridge LLC isolated resonant buck stage.

3. The power converter as recited in claim 1 wherein said controller is configured to provide a constant switching frequency for an input voltage greater than a threshold level.

4. The power converter as recited in claim 1 wherein said power converter is configured to power a string of light emitting diodes.

5. The power converter as recited in claim 1 wherein said controller is configured to reduce said switching frequency at low instantaneous values of said input voltage.

6. The power converter as recited in claim 1 wherein said controller is configured to sense a root-mean-square value of said input voltage to determine said switching frequency of said LLC stage.

7. The power converter as recited in claim 1 wherein controller is configured to modulate said switching frequency of said LLC stage based on an instantaneous value of said input voltage.

8. The power converter as recited in claim 1 wherein said controller is configured to employ a root-mean-square value and an instantaneous value of said input voltage to control said switching frequency of said LLC stage.

9. The power converter as recited in claim 1 further comprising a bridge rectifier coupled to said input of said power converter and said LLC stage.

10. The power converter as recited in claim 1 wherein said controller is configured to receive a feedback signal dependent on a current to control said switching frequency of said LLC stage.

11. The power converter as recited in claim 1 wherein said controller is configured to vary said switching frequency of said LLC stage inversely with an instantaneous value of said input voltage over a range of instantaneous values thereof.

12. A method of operating a power converter, comprising:
providing an inductor-inductor-capacitor (LLC) stage coupled to an input of said power converter; and
controlling a switching frequency of said LLC stage as a function of an input voltage of said power converter.

13. The method as recited in claim 12 further comprising providing a constant switching frequency for an input voltage greater than a threshold level.

14. The method as recited in claim 12 further comprising powering a string of light emitting diodes.

15. The method as recited in claim 12 further comprising reducing said switching frequency at low instantaneous values of said input voltage.

16. The method as recited in claim 12 further comprising sensing a root-mean-square value of said input voltage to determine said switching frequency of said LLC stage.

17. The method as recited in claim 12 further comprising modulating said switching frequency of said LLC stage based on an instantaneous value of said input voltage.

18. The method as recited in claim 12 further comprising employing a root-mean-square value and an instantaneous value of said input voltage to control said switching frequency of said LLC stage.

19. The method as recited in claim 12 further comprising receiving a feedback signal dependent on a current to control said switching frequency of said LLC stage.

20. The method as recited in claim 12 further comprising varying said switching frequency of said LLC stage inversely with an instantaneous value of said input voltage over a range of instantaneous values thereof.
